(19) United States
(12) Patent Application Publication
(10) Pub. No.: US 2017/0190135 A1
(43) Pub. Date: Jul. 6, 2017

(54) PRESSED CREASE-FORMING MEMBER

(71) Applicant: DIEPEX CO., LTD, Toyonaka-shi, Osaka (JP)

(72) Inventor: Takayuki TAKEUCHI, Osaka (JP)

(21) Appl. No.: 15/315,088

(22) PCT Filed: May 25, 2015
(86) PCT No.: PCT/JP2015/064905

§ 371 Date: Nov. 30, 2016

(30) Foreign Application Priority Data
Dec. 17, 2014 (JP) 2014-255288

(51) Int. Cl. B31F 1/10; B31F 1/08

(52) U.S. Cl. CPC B31F 1/10; B31B 1/00; B31F 1/08; B31B 1/25; B31B 2201/25

(57) ABSTRACT

A pressed crease-forming member is disclosed which is capable of forming a crease in a corrugated cardboard sheet along which the sheet can be bent with high accuracy, and which is a strip-shaped member having a crease-forming portion formed with an odd number of ribs extending in the longitudinal direction of the strip-shaped member with one of the ribs located at the widthwise center of the crease-forming portion. A plurality of cross grooves are formed on each side of the center rib, which is located at the widthwise center of the crease-forming portion, so as to be inclined relative to the center rib and spaced apart from each other in the longitudinal direction of the crease-forming portion. The cross grooves are arranged to longitudinally separate each of the ribs on both sides of the center rib into discontinuous rib portions.

### TECHNICAL FIELD

This invention relates to a pressed crease-forming member for forming a crease in a corrugated cardboard sheet or non-corrugated cardboard sheet so that the sheet can be bent along the crease, a template to which is mounted the pressed crease-forming member, and a creasing device.

### BACKGROUND ART

Corrugated cardboard sheets, which are each made up of a corrugated medium and liners glued to both sides of the corrugated medium, are available in various types and in different characteristics, according to the height and shape of corrugation of the corrugated medium, the thickness and quality of the corrugated medium, the thickness and quality of the liners, etc.

Such a corrugated cardboard sheet can be formed, by die-cutting, into e.g., a blank A₁ shown in FIG. 12, which is to be formed into a corrugated cardboard box. In particular, for this purpose, a template is used which includes a board to which are mounted die-cutting blades for forming the contour of the blank A₁ by die cutting, and pressed crease-forming members arranged inside the die-cutting blades and configured to form creases L₁ and L₂ in the blank A₁. Using this template, creases can be formed in the blank simultaneously when the blank is formed by die cutting. As the pressed crease-forming members, crease-forming rolls may be used.

The above-mentioned creases L₁ extend substantially parallel to the flutes C of the corrugated medium S₂ of the corrugated cardboard sheet A, while the creases L₂ extend perpendicular to the flutes C of the corrugated medium S₂.

FIG. 13 shows a conventional pressed crease-forming member 60 for forming creases L₁ and L₂. This pressed crease-forming member 60 comprises a strip-shaped member 61 made of metal and including a crease-forming portion 62 at one of an opposed pair of rectangular ends, and configured such that by pressing the crease-forming portion 62 into one side of the corrugated cardboard sheet A and partially crushing the corrugation of the corrugated medium S₂, groove-shaped creases L₁ and L₂ can be formed.

According to the characteristics of the corrugated cardboard sheet A, an optimum one is selected from among a plurality of strip-shaped member 61 having height dimensions, which are distances between the respective opposed pairs of ends, of about 20-plus millimeters, and having different wall thicknesses, which are distances between the respective two side surfaces, within the range of 0.5 mm to 7.0 mm.

The pressed crease-forming member 60 shown in FIG. 13 is used to form creases L₁ and L₂ in a corrugated cardboard sheet A having elasticity in the thickness direction thereof by pressing the crease-forming portion 62 into one side of the sheet A and crushing the corrugated medium S₂. Because the crease-forming portion 62 has a surface having a convex cross-section and having a smooth circular arc shape with no protrusions and recesses over the entire length thereof, and because the corrugated cardboard sheet A has large elasticity and thus has a tendency to return to its original shape, the creases L₁ and L₂ are not sufficiently sharp and clear, so that it is difficult to bend the corrugated cardboard sheet A along the creases L₁ and L₂ with high accuracy.

Especially in forming the creases L₁, which extend in parallel to the flutes C of the corrugated medium S₂, since different portions of the corrugated medium S₂ are crushed by the crease-forming portion 62, and a crease L₁ formed at a certain portion of the corrugated medium S₂ may be less sharper and clearer than a crease L₁ formed at a different portion of the corrugated medium S₂. This makes it all the more difficult to bend the corrugated cardboard sheet A with high accuracy.

Since the surface of the crease-forming portion 62 is smooth with no protrusions and recesses over the entire length thereof, especially when forming a crease L₁, i.e., a crease extending in parallel to the flutes C, according to the portion of the corrugated medium S₂ crushed by the crease-forming portion 62 to form the crease L₁, the surface of the corrugated cardboard sheet A may slip on the surface of the crease-forming portion 62 as the surface of the crease-forming portion 62 is pressed deeper into the corrugated cardboard sheet A, which could cause the sheet A to be moved in the direction perpendicular to the crease L₁, thus making it difficult to form the crease L₁ at the intended position with high accuracy, or causing the crease L₁ to meander.

The blank A₁ shown in FIG. 12 is formed into a flat box by bending the blank A₁ along two of the three parallel creases L₁ on both sides so that a glue tab P₅ integrally connected to a panel P₁ on one side of the blank A₁ is superposed on the end edge of a panel P₄ on the other side of the blank A₁, and adhesively bonding the superposed portions together.

At that time, if the blank A₁ is bent along the above two creases L₁ with insufficient accuracy, the panels P₁ and the panels P₄, which are on the opposite sides of the blank A₁, may be inclined relative to each other, or a flat box may not be formed with high accuracy due to inaccurate dimensions of the blank A₁ between the above two creases L₁. When such a flat box is erected into a rectangular tube, its side walls and/or end walls will be inclined such that the box is distorted with inaccurate inner dimensions.

In order to avoid these problems, the below-identified Patent document 1 proposes to form a V-shaped groove in the crease-forming portion of the pressed crease-forming member at its widthwise center to extend in parallel to one of the opposite long sides of the crease-forming portion, thereby defining a pair of protrusions on the respective sides of the groove. The below-identified Patent document 2 proposes to use two pressed crease-forming members spaced apart from each other so that the two pressed crease-forming members form two protrusions, and pressing the two pressed crease-forming members into a corrugated cardboard sheet.

### PRIOR ART DOCUMENTS

### Patent Documents

Patent document 1: JP Patent Publication 2010-284866A
Patent document 2: JP Patent Publication 9-48077A

### SUMMARY OF THE INVENTION

### Object of the Invention

In either of Patent documents 1 and 2, the pressed crease-forming member or members are mounted to a template, and a face plate formed with a pair of groove-shaped recesses is mounted on a flat lower board opposed to the template. In order to form a crease in the corrugated cardboard sheet by pushing corrugated cardboard sheet into the groove-shaped recesses with the pair of protrusions of the crease-forming portion or portions, the face plate has to be mounted on the lower board with high accuracy corresponding to the mounting position of the pressed crease-forming member or members on the template. It is therefore extremely troublesome and costly to set these members in position, and also, there is a problem in that the face plate tends to shift as creases are formed repeatedly.

Also, since there are only two protrusions for pressing the corrugated cardboard sheet, the area of the portion of the sheet which is pressed by the protrusions is small. Also, especially if a wide crease is formed, a large gap forms between the two protrusions. Since the sheet is not pressed at its portion corresponding to this large gap, the crease formed tends to be less clear if there were not for the groove-shaped recesses in the face plate. Thus in this arrangement, the groove-shaped recesses formed in the face plate are essential elements.

Since recesses and protrusions are formed, respectively, on one and the other surfaces of the corrugated cardboard sheet, the sheet is subjected to a large stress, which could cause the surface of the sheet to be torn, lower the strength of the sheet, or ruin its outer appearance, thereby lowering the commercial value of the sheet.

With the pressed crease-forming member disclosed in Patent document 1, since the groove formed in the widthwise center of the crease-forming portion is a V-shaped groove, the pair of protrusions formed on both sides of the groove have wedge shapes with pointed tips. The corrugated cardboard sheet thus tends to be damaged by the protrusions because high surface pressure is applied to the sheet when the sheet is pressed by the pointed tips of the protrusions.

On the other hand, since the pressed crease-forming member disclosed in Patent document 2 includes two pressed crease-forming members mounted separately to the template to define the protrusions, a difference in height between the protrusions tends to be created. Such a difference in height will cause two creases formed by the two protrusions in a corrugated cardboard sheet to have different depths from each other. This in turn results in the corrugated cardboard sheet being bent along the deeper one of the two creases, thus making it difficult to bend the corrugated cardboard sheet with high accuracy.

Further, the pressed crease-forming member of Patent document 2 could also damage a corrugated cardboard sheet because the pair of protrusions forcibly and strongly push the sheet into the groove-shaped grooves of the face plate, which face the respective protrusions. Moreover, the heights of the protrusions may change after many creases are formed. This makes it difficult to form two creases having the same depth in a corrugated cardboard sheet with the two protrusions. Also, since the pressed crease-forming member is constructed from three separate components, it is difficult to form narrow creases.

In either of Patent documents 1 and 2, since no protrusion is provided at the center of the crease-forming portion or each crease-forming portion, the crease or creases formed by such crease-forming portion or portions have no clear centerline(s), so that the corrugated cardboard sheet cannot be bent along the centerline of the crease or each crease with high accuracy.

An object of the present invention is to make it possible to form a crease in a corrugated cardboard sheet along which the sheet can be bent with high accuracy, without damaging the sheet.

### Means for Achieving the Object

In order to achieve this object, in the first invention, there is provided a pressed crease-forming member comprising a strip-shaped member made from metal and having a wall thickness of 7.0 mm or less, the strip-shaped member including a crease-forming portion at one end of the strip-shaped member, the crease-forming portion being capable of forming a crease in a sheet along which the sheet can be bent, by pressing the crease-forming portion into the sheet,

wherein the crease-forming portion has a surface on which are formed three or a larger-than-three odd number of ribs extending in a longitudinal direction of the crease-forming portion and having narrow widths which are substantially equal to each other, the ribs comprising a center rib located at a widthwise center of the crease-forming portion, and the remaining ribs, each half of the remaining ribs being arranged on each side of the center rib, the ribs have tops, of which at least the top of the center rib is chamfered, each of the ribs is formed into a protruding shape by two side surfaces extending toward the top, grooves are formed between the adjacent ribs, the side surfaces of the respective ribs extend from the respective tops of the ribs and are connected to opposed pairs of side surfaces of the grooves, whereby each of the grooves is formed into a recessed shape by the side surfaces of the groove, the tops of the ribs are arranged such that with the crease-forming portion facing downward, the top of the center rib is located at a lowest level of all the tops of the ribs, the tops of the odd number of ribs are formed, as a whole, into a convex shape, and recesses in the form of the grooves and protrusions in the form of the ribs other than the center rib are continuously formed on both sides of a protrusion in the form of the center rib, a plurality of cross grooves are formed on each of two sides of the center rib so as to extend in directions in which the respective cross grooves cross the center rib, so as to be spaced apart from each other in a longitudinal direction of the crease-forming portion, and so as to separate at least one of the ribs on said each of the two sides of the center rib into discontinuous rib portions.

The odd number of ribs and the cross grooves on both sides of the center rib may be formed on a crease-forming portion having a circular arc-shaped section and formed at one end of the strip-shaped member, or on a crease-forming portion having a flat section and formed at one end of the strip-shaped member.

When the crease-forming portion of this pressed crease-forming member is pressed against a sheet such as a corrugated cardboard sheet, the top of the center rib first abuts the sheet, and then the sheet is crushed, and the surface of the sheet smoothly moves along both side surfaces of the center rib and into the grooves of the crease-forming portion on both sides of the center rib. Then, the tops of the discontinuous rib portions on both sides of the center rib abut the sheet, so that the surface of the sheet is smoothly brought into abutment with both side surfaces of the respective discontinuous rib portions on both sides of the center rib. As a result, a corrugated crease is formed in the sheet by the crease-forming portion.

While the crease is being formed by the crease-forming portion, the sheet will never shift on the surface of the crease-forming portion toward either side of the center rib, so that a straight groove is formed in the sheet by the center rib at the accurate position.

Since the surface of the crease-forming portion is formed into a corrugated shape, the crease-forming portion is brought into contact with the surface of the sheet over a large surface area. This prevents the surface of the sheet from shifting relative to the surface of the crease-forming portion.

Since the sheet is brought into abutment with the protrusions and recesses on the surface of the crease-forming portion in a smooth sequential order, the sheet will never be torn when forming a crease in the sheet.

Discontinuous grooves are formed in the sheet at its portions corresponding to the discontinuous rib portions of the crease-forming portion; discontinuous ribs are formed in the sheet at its portions corresponding to the grooves of the crease-forming portion between the center rib and the corresponding discontinuous rib portions and between the discontinuous rib portions; and sharp and clear cross ribs are formed on the sheet at its portions corresponding to the cross grooves of the crease-forming portion.

At that time, since the surface of the sheet moves into the cross grooves, the sheet will never shift relative to the surface of the crease-forming portion in the longitudinal direction of the crease, so that the crease can be formed at the accurate position.

Since the fluted corrugated medium of the sheet is crushed strongly to a thin thickness at its portion where there is the straight groove, and the cross ribs are formed in a large number on both sides of the straight groove so as to be spaced apart from each other in the longitudinal direction of the straight groove, when the sheet is bent along the crease, the bending stress propagates along the cross ribs formed on both sides of the center rib to the straight groove, located at the widthwise center of the crease L. Also, since discontinuous ribs which extend in the longitudinal direction of the crease-forming portion are formed on the sheet between the respective pairs of cross ribs adjacent to each other in the longitudinal direction of the crease-forming portion, with the fluted corrugated medium of the sheet not crushed very strongly, and the bending strength of the sheet at its portions where there are the discontinuous ribs is higher than the bending strength at its portion where there is the straight groove, the corrugated cardboard sheet is bent along the straight groove. The crease thus allows accurate bending of the corrugated cardboard sheet.

Although the sheet is pushed with a strong force by the center rib, since its top is chamfered, the crease-forming portion can form a crease in the sheet without damaging the sheet.

By arranging the ribs of the crease-forming portion such that the protruding amount of the top of the center rib is larger than the protruding amounts of the tops of the discontinuous rib portions, the sheet is pushed hard by the center rib. This makes it possible to form a deep, clear and sharp straight groove at the widthwise center of the groove bottom of the crease. The sheet can thus be accurately and reliably bent with the straight groove as a starting point.

Preferably, the two side surfaces of at least the center rib are smooth inclined surfaces inclined in opposite directions to each other and having no corners such that at least the center rib is tapered. With this arrangement, the sheet can smoothly move along the inclined surfaces into the grooves on both sides of the center rib, so that a clear, V-shaped, straight groove is formed at the center of the crease. This makes it possible to accurately bend the sheet along the center of the crease.

Further preferably, with the crease-forming portion facing downward, the tops of the ribs on both sides of the center rib are arranged such that the farther away each of the ribs on both sides of the center rib is from the center rib toward each side of the crease-forming portion, the higher the top thereof is. With this arrangement, the tops of the ribs on both sides of the center rib are brought into abutment with the sheet in a smooth sequential order such that a portion of the sheet closer to the center of the crease formed is crushed more strongly, so that the sheet is less likely to be torn while a crease is being formed. Also, this makes it possible to bend the sheet accurately along the center of the crease.

In order to achieve the above object, in the second invention, there is provided a crease-forming template comprising a board which comprises plywood, and a pressed crease-forming member mounted to the board, and capable of forming a groove-shaped crease in a sheet along which the sheet can be bent, by pressing the pressed crease-forming member into the sheet,

wherein the pressed crease-forming member is the pressed crease-forming member of the first invention.

In order to achieve the above object, in the third invention, there is provided a creasing device comprising a support member, and a template opposed to the support member and including a board comprising plywood and a pressed crease-forming member mounted to the board, the creasing device being configured to form a groove-shaped crease in a sheet along which the sheet can be bent, by moving the template and the support member toward each other with the sheet supported on the support member, thereby pressing the pressed crease-forming member into the sheet,

wherein the template is the template of the second invention.

In order to achieve the above object, in the fourth invention, there is provided a creasing device comprising an anvil roll, a die roll opposed to the anvil roll, and a template mounted to an outer periphery of the die roll and including a cylindrical board comprising plywood, and a pressed crease-forming member mounted to the board, the creasing device being configured such that the pressed crease-forming member is capable of forming a groove-shaped crease in a sheet along which the sheet can be bent, when the sheet is fed into between the anvil roll and the die roll,

wherein the pressed crease-forming member is the pressed crease-forming member of the first invention.

In order to achieve this object, in the fifth invention, there is provided a creasing device comprising a support roll and a crease-forming roll which are configured to be rotated in opposite directions to each other, wherein the crease-forming roll includes a crease-forming portion including, on an outer periphery of the crease-forming portion, an annular crease-forming ring, the creasing device being configured such that the crease-forming ring forms a groove-shaped crease in a sheet along which the sheet can be bent, when the sheet is fed into between the support roll and the crease-forming roll,

wherein the crease-forming ring has an outer peripheral surface on which are formed three or a larger-than-three odd number of annular ribs extending in a circumferential direction of the crease-forming portion having narrow widths which are substantially equal to each other, the annular ribs comprising an annular center rib located at a widthwise center of the crease-forming portion, and the remaining annular ribs, each half of the remaining annular ribs being arranged on each side of the annular center rib, the annular ribs have tops, of which at least the top of the annular center rib is chamfered, each of the annular ribs is formed into a protruding shape by two side surfaces extending toward the top, circumferential grooves are formed between the adjacent annular ribs, the side surfaces of the respective annular ribs extend from the respective tops of the annular ribs and are connected to opposed pairs of side surfaces of the circumferential grooves, each of the circumferential grooves is formed into a recessed shape by each pair of the side surfaces of the circumferential grooves, the tops of the annular ribs are arranged such that the top of the annular center rib is largest in outer diameter of all the tops of the annular ribs, the tops of the odd number of ribs are formed, as a whole, into a convex shape, recesses in the form of the circumferential grooves and protrusions in the form of the annular ribs other than the annular center rib are continuously formed on both sides of a protrusion in the form of the annular center rib, and a plurality of cross grooves are formed on each of two sides of the center rib so as to extend in directions in which the respective cross grooves cross the center rib, so as to be spaced apart from each other in a longitudinal direction of the crease-forming portion, and so as to separate at least one of the ribs on said each of the two sides of the center rib into discontinuous rib portions.

### Advantages of the Invention

In any of the first to fifth inventions, when the crease-forming portion is pressed against a sheet, the top of the center rib first abuts the sheet, and then the sheet is crushed, and the surface of the sheet smoothly moves along both side surfaces of the center rib and into the grooves of the crease-forming portion on both sides of the center rib. Then, the tops of the discontinuous rib portions on both sides of the center rib abut the sheet one after another, so that the surface of the sheet is smoothly brought into abutment with both side surfaces of the respective ribs on both sides of the center rib. As a result, a corrugated crease is formed in the sheet by the crease-forming portion.

With this arrangement, since the surface of the sheet will never shift toward either side of the center rib relative to the surface of the crease-forming portion, the straight groove is formed in the sheet at the accurate position by the center rib. This allows the sheet to be bent with high accuracy.

Since the surface of the crease-forming portion includes protrusions in the form of the ribs, and recesses in the form of the grooves which are arranged alternately and continuously with the ribs, thus forming a corrugated shape, the crease-forming portion is brought into contact with the surface of the sheet over a large surface area. This prevents the surface of the sheet from shifting relative to the surface of the crease-forming portion.

Since the surface of the sheet moves into the cross grooves, the sheet will never shift relative to the surface of the crease-forming portion in the longitudinal direction of the crease-forming portion. This allows the crease to be formed at the accurate position.

Since the center rib is pushed more strongly than are the ribs on both sides of the center rib, thus weakening the sheet, a very deep, clear and sharp straight groove is formed at the widthwise center of the groove bottom of the crease. This makes it possible to accurately bend the sheet along the center of the crease.

Since the sheet is brought into abutment with the protrusions and recesses on the surface of the crease-forming portion in a smooth sequential order, the sheet will never be torn when forming a crease in the sheet.

Since a portion of the sheet closer to the center of the crease formed is crushed more strongly, the sheet is less likely to be torn while a crease is being formed. Also, this makes it possible to bend the sheet accurately along the center of the crease.

Although the sheet is pushed with a strong force by the center rib, since its top is chamfered, the crease-forming portion can form a crease in the sheet without damaging the sheet.

By pressing this crease-forming portion into the sheet, a crease is formed having a groove bottom formed with a straight groove at the widthwise center thereof, discontinuous grooves on each side of the straight groove, discontinuous ribs between the respective pairs of discontinuous grooves adjacent to each other in the width direction of the crease-forming portion, and cross ribs on each side of the straight groove. Since the cross ribs are arranged such that when the sheet is bent along the crease, the bending stress propagates through the cross rib to straight groove at the widthwise center of the crease, the sheet can be bent with high accuracy.

### BRIEF DESCRIPTION OF THE DRAWINGS

FIG. 1(I) is a vertical sectional view of a creasing device according to the present invention; and FIG. 1(II) is a vertical sectional view of the creasing device, showing how a crease is formed.

FIG. 2 is an enlarged sectional view of a portion of FIG. 1(II).

FIG. 3 is a bottom plan view of a pressed crease-forming member shown in FIG. 2.

FIG. 4 is a sectional view taken along line IV-IV of FIG. 3.

FIG. 5 is a sectional view taken along line V-V of FIG. 3.

FIG. 6(I) is a plan view of a sheet showing a crease formed in the sheet by the pressed crease-forming member shown in FIG. 3; and FIG. 6(II) is a sectional view taken along line VI-VI of FIG. 6(I).

FIG. 7 is a sectional view of a different pressed crease-forming member according to the present invention.

FIG. 8 is a sectional view of a further different pressed crease-forming member according to the present invention.

FIG. 9(I) is a vertical sectional view of a creasing device according to the present invention; and FIG. 9(II) is a perspective view of a portion of a pressed crease-forming member of the creasing device shown in FIG. 9(I).

FIG. 10(I) is a vertical sectional view of a different creasing device according to the present invention; FIG. 10(II) is a side view thereof; and FIG. 10(III) is a perspective view of a portion of a crease-forming roll of the creasing device shown in FIG. 10(I).

FIG. 11 is a bottom plan view of a still different pressed crease-forming member according to the present invention.

FIG. 12 is a partially cutaway front view of a blank to be formed into a corrugated cardboard box.

FIG. 13 is a perspective view of a conventional pressed crease-forming member.

### BEST MODE FOR EMBODYING THE INVENTION

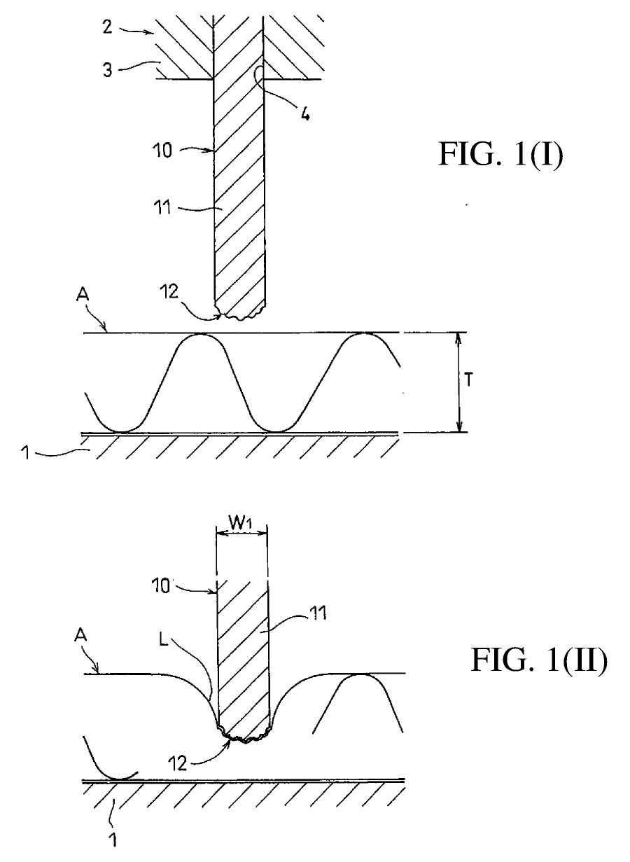

An embodiment of the present invention is described with reference to the drawings. FIGS. 1(I) and 1(II) show a creasing device for forming creases in a corrugated cardboard sheet. The creasing device includes a support member or support plate 1 having a flat surface (i.e., a surface with no recesses and protrusions) and capable of supporting a corrugated cardboard sheet A. The creasing device further includes a template 2 opposed to, and movable toward and away from, the support plate 1. The template 2 includes a flat board 3 comprising plywood and having a groove-like mounting hole 4 formed, e.g., by a laser beam, and a pressed crease-forming member 10 press-fitted into the mounting hole 4 in the height direction of the creasing device.

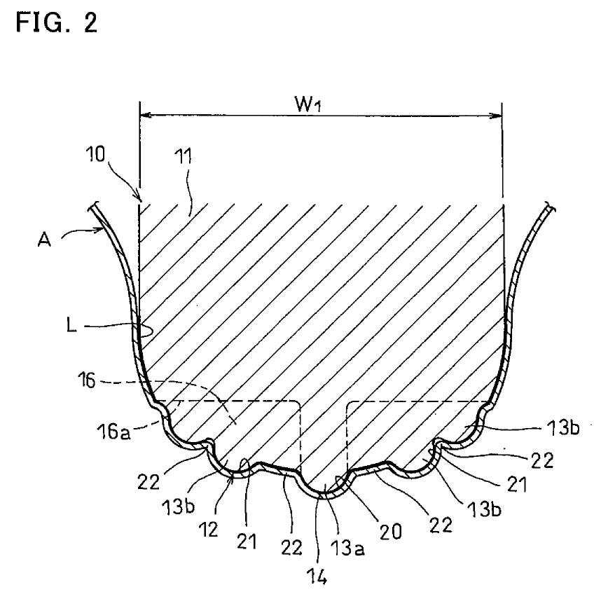

As shown in FIGS. 2 to 5, the pressed crease-forming member 10 is a strip-shaped member 11 made from metal and having a height, which is the distance between the vertically opposed rectangular ends of the member 10, of about 20-plus millimeters, a wall thickness W₁, which is the distance between the two side surfaces of the member 10, of about 0.5 mm-7.0 mm, and having a suitable length. One of the upper and lower rectangular end portions of the strip-shaped member 11 is used as a crease-forming portion 12. As this pressed crease-forming member 10, one having suitable dimensions is selected and used according to the characteristics of the corrugated cardboard sheet A.

The crease-forming portion 12 has a convex, circular arc-shaped section as a whole and has an odd number of protruding ribs 13 extending in the longitudinal direction of the crease-forming portion 12 while being spaced apart from each other in the width direction of the crease-forming portion 12. In the example shown, five ribs 13 are provided, but any other odd number of ribs may be used.

One of the five ribs 13, i.e., the center rib 13a, is located at the widthwise center of the crease-forming portion 12, and two of the remaining four ribs 13b are provided on either side of the center rib 13a so as to be symmetrical to the other two ribs 13b with respect to the center rib 13a.

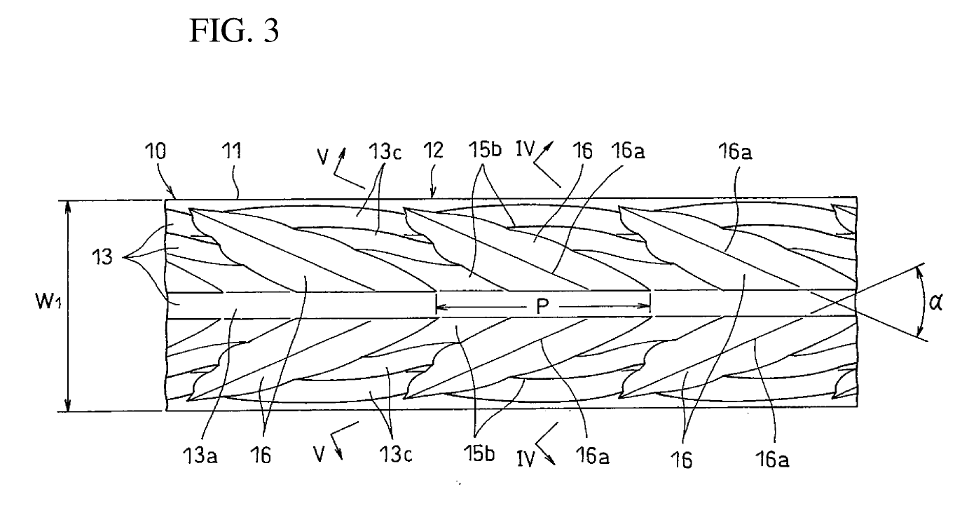

In FIGS. 2, 4 and 5, the distances between the center rib 13a and the ribs 13b and between the ribs 13b are different, but they may be equal to each other. As shown in FIG. 3, some of them may be arranged adjacent to each other.

Each rib 13 has two straight inclined side surfaces which are inclined in opposite directions to each other and extend to its top 14 so that the rib 13 has a substantially V-shaped cross-section tapered toward the top 14.

In the embodiment, the top 14 of each rib 13 is chamfered so as to have a circular arc-shaped cross-section, but it may be chamfered so as to have a polygonal cross-section.

Also, at least the top 14 of the center rib 13a, and not all of the tops 14, may be chamfered.

The center rib 13a and the ribs 13b on both sides of the center rib 13a are all narrow in width and substantially equal in width to each other. The widths of the tops 14 are determined according to the wall thickness W₁ of the strip-shaped member 11 and the number of ribs 13, and are about one-third of the wall thickness W1 (which is 0.5 mm-7.0 mm).

Both inclined surfaces (side surfaces) of each rib 13 would be easily formable if they are smooth straight surfaces having no corners, but they may be smoothly curved or corrugated inclined surfaces having no corners so that the rib 13 is tapered toward the top 14.

When both side surfaces of each rib 13, which extend to the top 14, are inclined surfaces inclined in opposite directions to each other to form an acute angle therebetween, a sharper crease L can be formed in the corrugated cardboard sheet A, but they may be arranged to form an obtuse angle therebetween. By arranging the side surfaces to form an obtuse angle therebetween, the rib 13 is less likely to damage the corrugated cardboard sheet A.

When the side surfaces of each rib 13 are inclined surfaces, the corrugated cardboard sheet A can be more easily formed along the inclined surfaces, but they may be vertically extending surfaces. By arranging the side surfaces to extend vertically, a sharper crease L can be formed in the corrugated cardboard sheet A.

In FIG. 3, the center rib 13a extends continuously in a straight line, but the center rib 13a may be interrupted by a plurality of small cutouts formed in the top 14, provided the center rib 13a extends in a straight line.

The inclined side surfaces of each adjacent pair of the ribs 13 that are opposed to each other extend away from the respective tops 14, and are continuously connected to inclined surfaces inclined in opposite directions to each other. The latter two inclined side surfaces, which extend smoothly in a straight line and have no corners, form a V-shaped concave groove 15 which is tapered toward its bottom and continuous with the ribs 13 on both sides of the groove 15.

The bottoms of the concave grooves 15 are chamfered so as to have a rounded cross-section, but may be chamfered so as to have a polygonal cross-section.

If the grooves 15 are deep, the corrugated cardboard sheet A may not reach the bottoms of the grooves 15. In such a case, the bottoms of the grooves 15 may not be chamfered.

Both inclined surfaces of each groove 15 would be easily formable if they are smooth straight surfaces having no corners, but they may be smoothly curved or corrugated inclined surfaces having no corners so that the groove 15 is tapered toward the bottom.

As described above, since the side surfaces of the ribs 13 are smoothly connected to the respective side surfaces of the grooves 15 with no corners therebetween so that the side surfaces continuously extend from the tops 14 of the ribs 13 to the bottoms of the grooves 15, the crease-forming portion 12 has a smooth continuous surface comprising the protrusions in the form of the ribs 13, and the recesses in the form of the grooves 15 which alternate with the protrusions, with the center rib 13a protruding beyond the other ribs 13b.

The crease-forming portion 12 of the strip-shaped member 11 is shaped such that with the strip-shaped member 11 in the crease-forming position, in which the crease-forming portion 12 faces downward, the top 14 of the center rib 13a, which is positioned on the widthwise center of the crease-forming portion 12, is located at the lowest level, with the tops 14 of the ribs 13b on both sides of the center rib 13a located such that the farther apart these tops 14 are from the top 14 of the center rib 13a, the higher they are located, whereby the tops 14 of all of the ribs 13, which are spaced apart from each other in the width direction, are formed into a downwardly convex shape as a whole, with the center rib 13a, which protrudes beyond the other ribs 13b, located at the center.

When the center rib 13a protrudes downward beyond the other ribs 13b, instead of arranging the tops 14 of the ribs 13b on both sides of the center rib 13a such that the farther away these tops 14 are from the top 14 of the center rib 13a, the higher they are located, some of these tops 14 may be of the same height such that the tops 14 are formed into a downwardly convex shape as a whole.

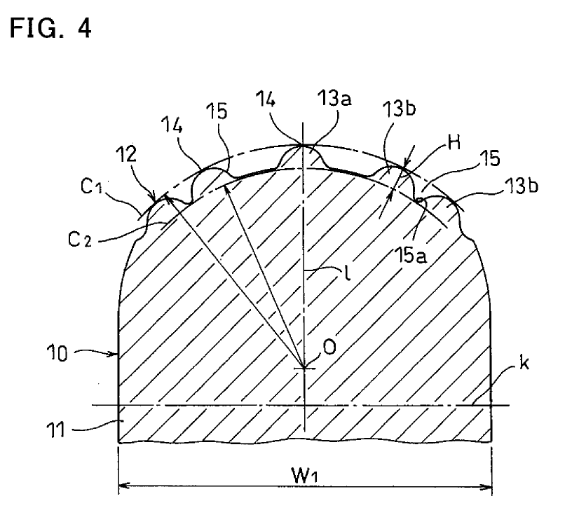

As shown in FIG. 4, the five ribs 13a and 13b are arranged such that their tops 14 are in contact, from inside, with an imaginary circular arc-shaped curved line in the form of an imaginary circle C₁ having a center at a point O on a widthwise centerline 1 extending parallel to the side surfaces of the strip-shaped member 11 while passing through the widthwise center of the strip-shaped member 11. However, the imaginary curved line may be an arc-shaped line other than a circular arc-shaped line, provided it is a smooth, convex line symmetrical with respect to the widthwise center line of crease-forming portion 12, and high at the center, such as an oval line or a parabolic line.

The plurality of grooves 15, which are formed between the respective pairs of ribs 13 adjacent to each other in the width direction of the crease-forming portion 12, are arranged such that the bottoms 15a of the grooves 15 are in contact, from outside, with an imaginary circle C₂ whose center is at the above point O, and which is smaller in diameter than, and located within, the imaginary circle C₁, whereby the heights (protruding amounts) H of the tops 14 of the respective ribs 13a and 13b from the imaginary circle C₂ (i.e., the depths of the grooves 15, which are the distances from the bottoms 15a of the respective grooves 15 to the tops 14 of the ribs 13a and 13b) are equal to each other.

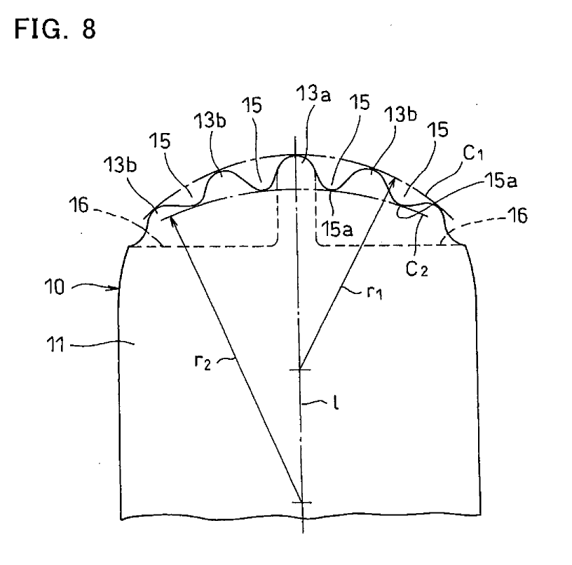

While in FIG. 4, the heights H of the plurality of ribs 13a and 13b are equal to each other, the ribs 13 may be arranged such that the center rib 13a is the highest, and the farther away the ribs 13b are from the center rib 13a, the smaller their heights H are, or such that only the center rib 13a is larger in height H than the other ribs. In FIG. 8, the imaginary circle C₂, with which the bottoms 15a of the grooves 15 are in contact, has a radius r₂ which is larger than the radius r₁ of the imaginary circle C₁, with which the tops 14 of the ribs 13a and 13b are in contact, so that the center rib 13a is the largest in height H, and the farther away the ribs 13b are from the center rib 13a, the smaller their heights H are.

As shown in FIGS. 3 to 5, the crease-forming portion 12 is formed, on both sides of the center rib 13a, with opposed pairs of cross grooves 16 which extend so as to cross the center rib 13a and are inclined relative to the longitudinal direction of the center rib 13a, and which are equidistantly spaced apart from each other in the longitudinal direction of the strip-shaped member 11. Each opposed pair of the cross grooves 16 extend from their starting ends at the respective sides of the center rib 13a toward the respective sides of the strip-shaped member 11 while being inclined in opposite directions to each other. The starting ends of each pair of cross grooves 16 are at the same position in the longitudinal direction of the center rib 13a, so that each pair of cross grooves 16 are symmetrical to each other with respect to the center rib 13a, forming a Japanese character “ [symbol] ”.

However, provided that each pair of cross grooves 16 form the Japanese character “ [symbol] ”, they may not be symmetrical with respect to the center rib 13a.

The cross grooves 16 have a V-shaped cross-section and include groove bottoms 16a located at lower positions than the groove bottoms of the grooves 15 formed between the respective pairs of ribs 13a and 13b that are adjacent to and opposed to each other in the width direction of the crease-forming portion 12. The cross grooves 16 on each side of the center rib 13a extend across the corresponding two ribs 13b on this side, thereby longitudinally separating each of the two ribs 13b into a plurality of discontinuous rib portions 13c.

The cross grooves 16 also separate each of the grooves 15, which are formed between the respective pairs of ribs 13a and 13b that are adjacent to and opposed to each other in the width direction of the crease-forming portion 12 and which extend in the longitudinal direction, into a plurality of longitudinally discontinuous groove portions 15b.

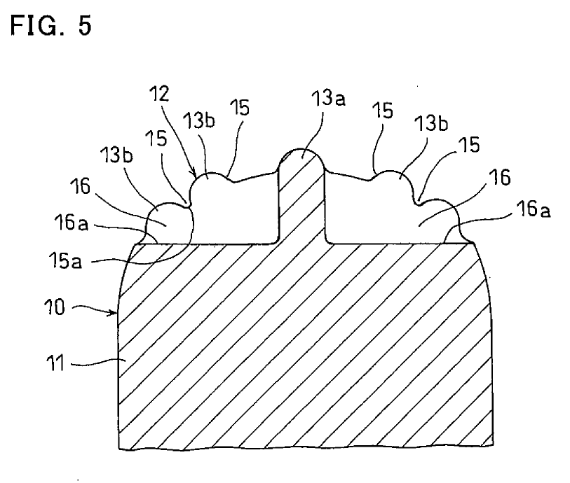

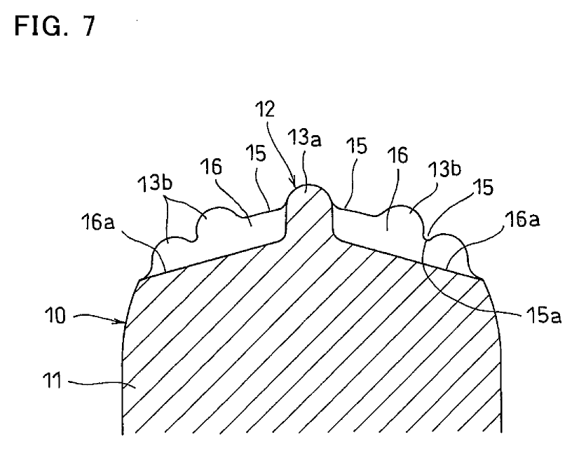

While in FIG. 5, the groove bottoms 16a of the cross grooves 16 extend perpendicular to the side surfaces of the strip-shaped member 11, and thus in a horizontal direction, they may be, as shown in FIG. 7, downwardly inclined toward the respective side surfaces of the strip-shaped member 11.

The groove bottoms 16a of the cross grooves 16 may be at the same height as the groove bottoms of the grooves 15, or may be at a higher level that the groove bottoms of the grooves 15, provided the cross grooves 16 extend across the ribs 13 and the grooves 15 such that each rib 13b and each groove 15 are separated, in the longitudinal direction of the crease-forming portion 12, into the plurality of discontinuous rib portions 13c and the plurality of discontinuous groove portions 15b, respectively.

In the embodiment shown in FIG. 3, the ribs 13 other than the center rib and the grooves 15 extend, in a corrugated pattern, in the longitudinal direction of the crease-forming portion 12, so that the discontinuous rib portions 13c and the discontinuous groove portions 15b, which are formed by the cross grooves 16, which extend across the corrugated ribs 13 and the grooves 15, so as to be separated from each other in the longitudinal direction of the crease-forming portion 12, are also corrugated. However, the ribs 13 other than the center rib and the grooves 15 may extend in a straight line in the longitudinal direction of the crease-forming portion 12 so that straight longitudinally discontinuous rib portions 13c and straight longitudinally discontinuous groove portions 15b are formed by the cross grooves 16, which extend across the ribs 13b and the grooves 15.

As shown in FIG. 4, the ribs 13a and 13b are arranged such that the closer the top 14 of each rib 13 is to the centerline 1 at the widthwise center of the pressed crease-forming member 10, the larger the distance between the top 14 of the rib 13 and a reference line k extending between, and perpendicular to, the side surfaces of the pressed crease-forming member 10, and thus the rib 13 protrudes to a larger degree so that the crease-forming portion 12 is formed, as a whole, into a convex shape.

In the embodiment shown in FIG. 4, the strip-shaped member 11 of the pressed crease-forming member 10 has, at one end portion thereof, a convex curved section as a whole, with the tops 14 of the ribs 13a and 13b arranged on a circular arc such that the closer each top 14 is to centerline 1, the higher it is.

Since the pressed crease-forming member 10 comprises a single integral strip-shaped member 11 made from a metal, it has the following advantages:

(1) Since the pressed crease-forming member 10 is manufactured by cutting one end of the single integral strip-shaped member 11, even if the strip-shaped member 11 is narrow in width, an odd number of ribs 13 and grooves 15 can be easily formed so as to be smoothly continuous with each other.
(2) The pressed crease-forming member 10 can be easily mounted to the template 2 while being positioned accurately.
(3) Once the pressed crease-forming member 10 comes into abutment with the support plate 1, the tips of the odd number of ribs 13 are less likely to be displaced from each other, so that relative displacement is prevented.
(4) Since the pressed crease-forming member 10 is manufactured by cutting one end of the single integral strip-shaped member 11, even if the strip-shaped member 11 is narrow in width, an odd number of ribs 13 and grooves 15 can be easily formed so as to be smoothly continuous with each other.
(5) The pressed crease-forming member 10 can be easily mounted to the template 2 while being positioned accurately.
(6) Once the pressed crease-forming member 10 comes into abutment with the support plate 1, the tips of the odd number of ribs 13 are less likely to be displaced from each other, so that relative displacement is prevented.
(7) Since the pressed crease-forming member 10 is made from a metal, it is less likely to become worn, and less likely to be deformed in shape. The corrugated cardboard sheet A can thus be crushed strongly.

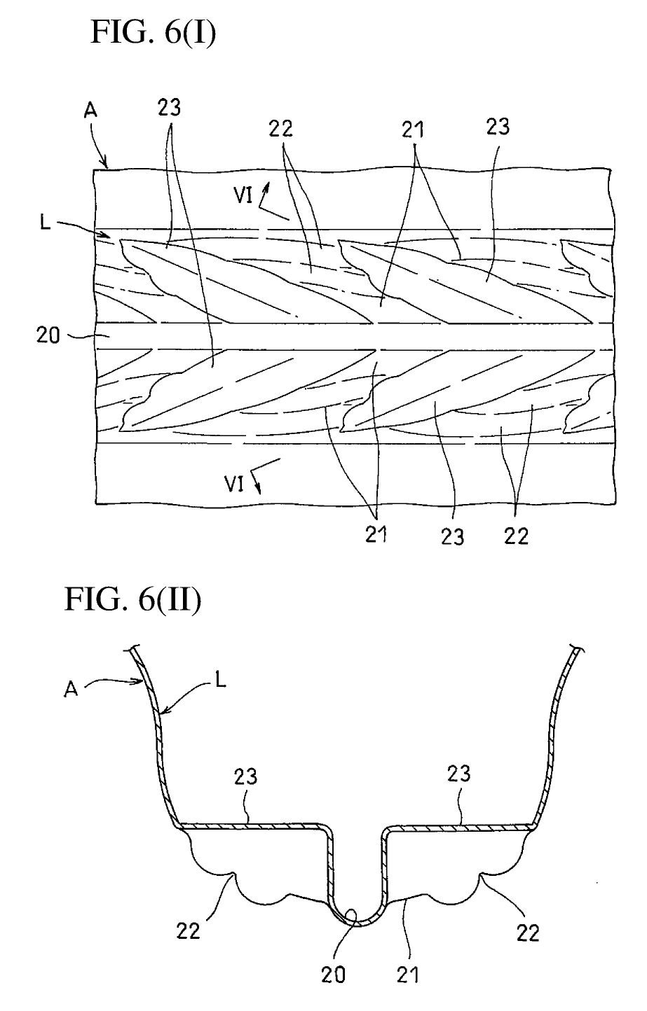

With this creasing device, when, as shown in FIG. 1(I), the template 2 is lowered toward the flat support plate 1, which is provided under and opposed to the template 2, with the corrugated cardboard sheet A supported on the support plate 1, as shown in FIG. 1(II), the crease-forming portion 12 of the pressed crease-forming member 10 presses the corrugated cardboard sheet A and crushes the corrugated medium of the corrugated cardboard sheet A, thus forming, as shown in FIGS. 6(I) and 6(II), a deep crease L having a width corresponding to the wall thickness W1 of the strip-shaped member 11 in the corrugated cardboard sheet A.

At that time, the center rib 13a and the discontinuous rib portions 13c, which are formed on the crease-forming portion 12 to extend in the longitudinal direction, press the corrugated cardboard sheet A in a sequential order. When the corrugated cardboard sheet A is pressed, the corrugated cardboard sheet A is deformed such that the corrugated cardboard sheet A bulges and moves into the grooves 15 and the cross grooves 16 on both sides of the center rib 13a, which are formed between the center rib 13a and the discontinuous rib portions 13c adjacent to the center rib 13a and between the adjacent discontinuous rib portions 13c, thereby forming ribs on the corrugated cardboard sheet A. A crease is thus formed in the corrugated cardboard sheet A by the crease-forming portion.

Thus, the portions of the corrugated cardboard sheet A corresponding to the center rib 13a and the discontinuous rib portions 13c of the crease-forming portion 12 are pushed in such that, as shown in FIGS. 6(I) and 6(II), a crease L is formed which includes a deep and clear straight groove 20 formed at an accurate position corresponding to the center rib 13a so as to extend in the longitudinal direction of the crease L, and discontinuous grooves 21 formed at positions corresponding to the discontinuous rib portions 13c.

Since the center rib 13a and the discontinuous rib portions 13c are narrow in width, the straight groove 20 and the discontinuous grooves 21, formed by them, are also narrow in width and clear and sharp.

The surface of the corrugated cardboard sheet A abuts the top 14 of the center rib 13a first. Then, while the corrugated cardboard sheet A is crushed, its surface is smoothly moved along both inclined side surfaces of the center rib 13a into the grooves 15 on both sides, and then is brought into abutment with the tops 14 of the discontinuous rib portions 13c on both sides of the center rib 13a, and then with both inclined surfaces of the respective discontinuous rib portions 13c on both sides of the center rib 13a. As a result, a corrugated crease is formed in the corrugated cardboard sheet A.

Thus, even if a crease L is to be formed to extend parallel to the flutes C, the corrugated cardboard sheet A will never be displaced or moved toward either side of the center rib 13a, relative to the surface of the crease-forming portion 12. Thus, the straight groove 20 is formed at an accurate position of the corrugated cardboard sheet A by the center rib 13a.

Since the surface of the crease-forming portion 12 includes protrusions in the form of the ribs 13, and recesses in the form of the grooves 15 which are arranged alternately and continuously with the ribs, thus forming a corrugated shape, the crease-forming portion 12 is brought into contact with the surface of the corrugated cardboard sheet A over a large surface area. This prevents the surface of the corrugated cardboard sheet A from shifting relative to the surface of the crease-forming portion 12.

The crease L further includes discontinuous ribs 22 formed at its portions corresponding to the grooves 15, which is defined between the center rib 13a and the discontinuous rib portions 13c and between the discontinuous rib portions 13c, and pairs of clear and sharp cross ribs 23 inclined in the shape of the Japanese character “ [symbol] ” and formed at portions corresponding to the right and left pairs of “ [symbol] ”-shaped symmetrical cross grooves 16, having a V-shaped cross-section.

Since the surface of the corrugated cardboard sheet A moves into the cross grooves 16 while the crease L is being formed, the corrugated cardboard sheet A will never be displaced relative to the crease-forming portion 12 in the longitudinal direction of the crease-forming portion 12. This makes it possible to form the crease at an accurate position.

Since the corrugated cardboard sheet A is the thinnest at its portion where there is the straight groove 20, and the cross ribs 23 are formed on both sides of the straight groove 20 so as to be equidistantly spaced apart from each other in the longitudinal direction of the straight groove 20, when the corrugated cardboard sheet A is bent along the crease L, the bending stress propagates along the cross ribs 23 to the straight groove 20, located at the widthwise center of the crease L. Also, since the discontinuous ribs 22 are formed between the respective pairs of cross ribs 23 adjacent to each other in the longitudinal direction of the crease-forming portion 12, and the bending strength of the sheet A at its portions where there are the discontinuous ribs 22 is higher than the bending strength at its portion where there is the straight groove 20, the corrugated cardboard sheet A is bent along the straight groove 20. The crease L thus allows accurate bending of the corrugated cardboard sheet A.

In the embodiment, the two side surfaces of each of the odd number of ribs 13 are inclined in opposite directions to each other, but the side surfaces of at least only the center rib 13a, of the odd number of ribs 13, may be inclined in opposite directions to each other so as to have no corners so that at least only the center rib 13a is tapered toward its top. In this case too, the corrugated cardboard sheet A smoothly and effortlessly moves into the grooves 15 along the inclined surfaces, and as a result, a V-shaped, straight groove 20 is formed clearly and sharply at the widthwise center of the crease L, which makes it possible to accurately bend the corrugated cardboard sheet A along the center of the crease L.

Since the cross grooves 16 of the crease-forming portion 12 of the pressed crease-forming member 10 are formed on both sides of the center rib 13a so that each pair of them are symmetrical to each other and form the Japanese character “ [symbol] ”, the cross ribs 23 are also arranged, as shown in FIGS. 6(I) and 6(II), such that each pair of them are symmetrical to each other with respect to the straight groove 20 and form the Japanese character “ [symbol] ”. Thus, when the corrugated cardboard sheet A is bent along the crease L, the bending stress propagates all the more uniformly along the inclined cross ribs 23 to the straight groove 20 at the widthwise center of the crease L. The crease L thus allows all the more accurate bending of the corrugated cardboard sheet A.

Since the discontinuous rib portions 13c that are located closer to the center rib 13a press the corrugated cardboard sheet A harder, thus reducing the thickness of the sheet A, and weakening the sheet A, to a greater degree, the corrugated cardboard sheet A can be accurately bent along the straight groove 20 at the center.

Since, as shown in FIG. 4, the center rib 13a and the discontinuous rib portions 13c, which are to be pressed into the corrugated cardboard sheet A, have their tops 14 rounded by chamfering, they will not damage the corrugated cardboard sheet A when forming the crease L.

If the discontinuous rib portions 13c and the discontinuous groove portions 15b are corrugated, the discontinuous rib portions 13c are brought into contact with the corrugated cardboard sheet A over a larger length when forming a crease in the sheet A, so that the discontinuous rib portions 13c can more effectively prevent the sheet A from being displaced, thus making it possible to form a crease in the sheet A more accurately.

Since the surface of the support plate 1 is flat, no excessive force will act on the corrugated cardboard sheet A when forming a crease by pressing the pressed crease-forming member 10 into the sheet A, even if the pressed crease-forming member 10 is pressed hard into the sheet A, so that the sheet A will never be broken.

Since an odd number of the ribs 13a and 13b are provided, this pressed crease-forming member 10 can be especially advantageously used to form creases L in corrugated cardboard sheets A and cardboard, which have large wall thicknesses, by pressing it into them.

In order to more accurately bend the corrugated cardboard sheet A along the crease L, the crease-forming portion 12 is preferably shaped symmetrical with respect to the centerline 1 shown in FIG. 4.

If the height H, shown in FIG. 4, of the rib 13a is lower than necessary, it may be impossible to form a clear and sharp straight groove 20, while if the height H is higher than necessary, the curvature of the top 14 may be so small that the top 14 could damage the corrugated cardboard sheet A.

Thus, while also depending on the characteristics of the corrugated cardboard sheet A and the wall thickness W₁ of the strip-shaped member 11, the heights H of the ribs 13a and 13b are most preferably about 0.1 mm, and should be within the range of 0.05 mm-1.0 mm.

The number of the ribs 13a and 13b is preferably within the range of three to 21, though dependent on the characteristics of the corrugated cardboard sheet A and the wall thickness W₁ of the strip-shaped member 11. For example, if the wall thickness W₁ is 2.0 mm, the number of the ribs 13a and 13b is preferably five or around five, and if the wall thickness W₁ is 3.0 mm, the number of the ribs 13a and 13b is preferably seven or around seven.

The pitches of the right and left opposed pairs of cross grooves 16, which are spaced apart from each other in the longitudinal direction of the crease-forming portion 12, are preferably equal to each other, but may be different from each other.

Since the crease L formed by this crease-forming portion 12 includes discontinuous ribs 22 at portions corresponding to the grooves 15 formed between the center rib 13a and the corresponding discontinuous rib portions 13c and between the discontinuous rib portions 13c, and pairs of clear, “ [symbol] ”-shaped cross ribs 23 at portions corresponding to the right and left opposed pairs of cross grooves 16, each pair being arranged symmetrically and forming the Japanese character “ [symbol] ”, the corrugated cardboard sheet A can be bent accurately and reliably along the straight groove 20.

There are various corrugated cardboard sheets A which are different in characteristics, and if the wall thickness W₁, shown in FIG. 1(II), of the strip-shaped member 11 is larger than the thickness T of the corrugated cardboard sheet A, the crease L formed will have a width larger than necessary to such an extent that it is difficult to clearly specify the bending position, i.e., to bend the sheet A with high accuracy. This will make it difficult to prepare boxes whose inner dimensions are constant by bending such corrugated cardboard sheets A. Thus, the strip-shaped member 11 preferably satisfies the relation W₁<T.

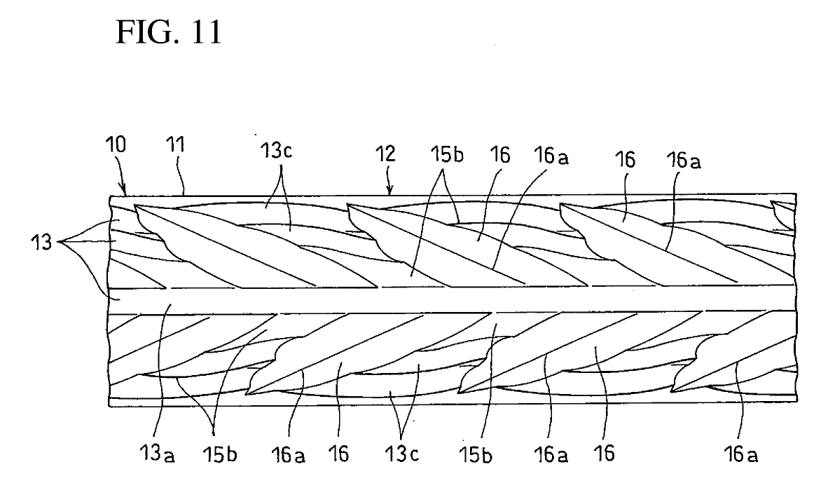

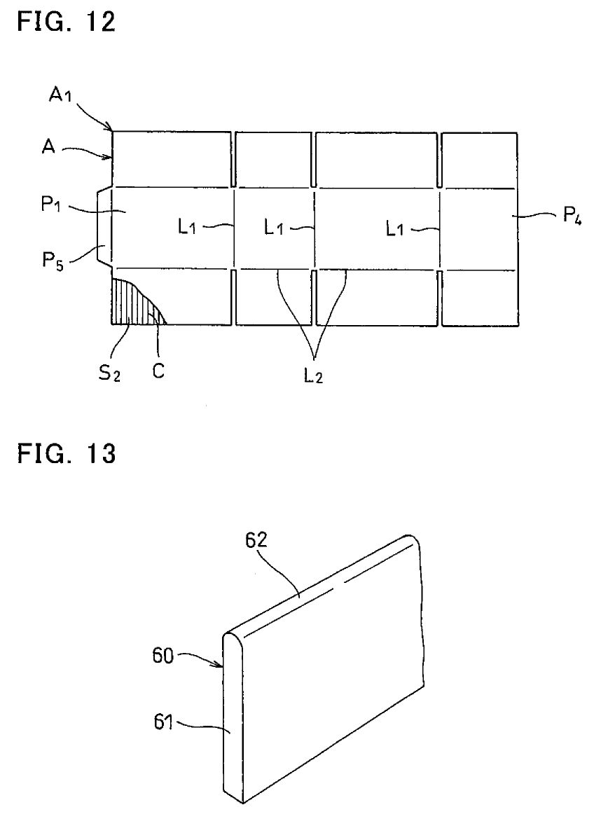

While the pressed crease-forming member 10 shown in FIG. 3 include pairs of cross grooves 16 provided on both sides of the center rib 13a, each pair being arranged symmetrically with respect to the center rib 13a and forming the Japanese character “ [symbol] ”, the pressed crease-forming member shown in FIG. 11 includes first cross grooves 16 extending from one side of the center rib 13a at its portions spaced apart from each other in the longitudinal direction of the center rib 13a, toward the corresponding side surface of the strip-shaped member 11, and second cross grooves 16 extending from the other side of the center rib 13a at its portions spaced apart, in the longitudinal direction of the center rib 13a, from each other and from the portions from which the first cross grooves 16 extend, toward the corresponding side surface of the strip-shaped member 11.

The cross grooves 16 may be formed so as to extend in a direction in which they cross the center rib 13a at a right angle. Such grooves can be formed more easily.

When bending the corrugated cardboard sheet A along a crease L formed by such a pressed crease-forming member 10 too, the bending stress propagates along the cross ribs to the straight groove at the widthwise center of the crease L, so that the corrugated cardboard sheet A can be bent with high accuracy.

The cross grooves 16 may be arranged at different intervals in the longitudinal direction of the center rib 13a. Instead of the cross grooves 16 shown, shorter cross grooves 16 may be provided both sides of the center rib 13a such that those on each side of the center rib 13a extend across only one of the ribs 13b on each side of the center rib 13a, including the rib 13b adjacent to the center rib 13a, to separate only this particular rib 13b into discontinuous rib portions 13c.

The ribs 13b, the discontinuous rib portions 13c, and the discontinuous groove portions 15b may not be symmetrically arranged with respect to the center rib 13a.

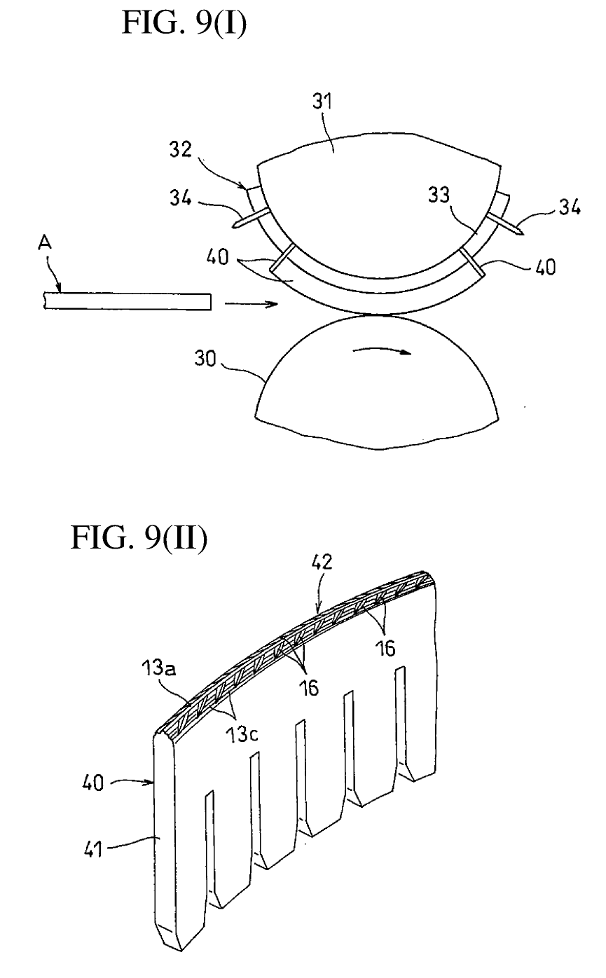

FIGS. 9(I) and 9(II) show a creasing/die-cutting device. This device includes an anvil roll 30 as a support member which has a smooth surface with no protrusions and recesses, and a die roll 31 opposed to the anvil roll 30. A template 32 comprising an arc-shaped board 33 is mounted to the outer periphery of the die roll 31, and die-cutting blades 34 and pressed crease-forming members 40 are mounted to the arc-shaped board 33 so that when a corrugated cardboard sheet A is fed into between the anvil roll 30 and the die roll 31 with the rolls 30 and 31 rotating in opposite directions to each other, the die-cutting blades 34 cut the corrugated cardboard sheet A to a predetermined shape, and simultaneously, the pressed crease-forming members 40 form creases in the corrugated cardboard sheet A.

As shown in FIG. 9(II), each pressed crease-forming member 40 for forming a crease extending in the feed direction of the corrugated cardboard sheet A is a strip-shaped member 41 comprising an arc-shaped metal strip formed with a crease-forming portion 42 on the peripheral surface at the radially outer end the strip-shaped member 41. The crease-forming portion 42 includes a center rib 13a, discontinuous rib portions 13c, grooves 15, and cross grooves 16 which are, if flattened, exactly identical in shape, structure and arrangement to their counterparts shown in FIGS. 3 to 5. Their details are however not shown in FIG. 9(II).

The pressed crease-forming members 40 are capable of forming creases L similar to the crease L shown in FIGS. 3 to 5, so that the corrugated cardboard sheet A can be bent along the creases L with high accuracy.

As the crease-forming portions 42, ones similar to the crease-forming portion 12 shown in any of FIGS. 7, 8 and 11 may be used instead.

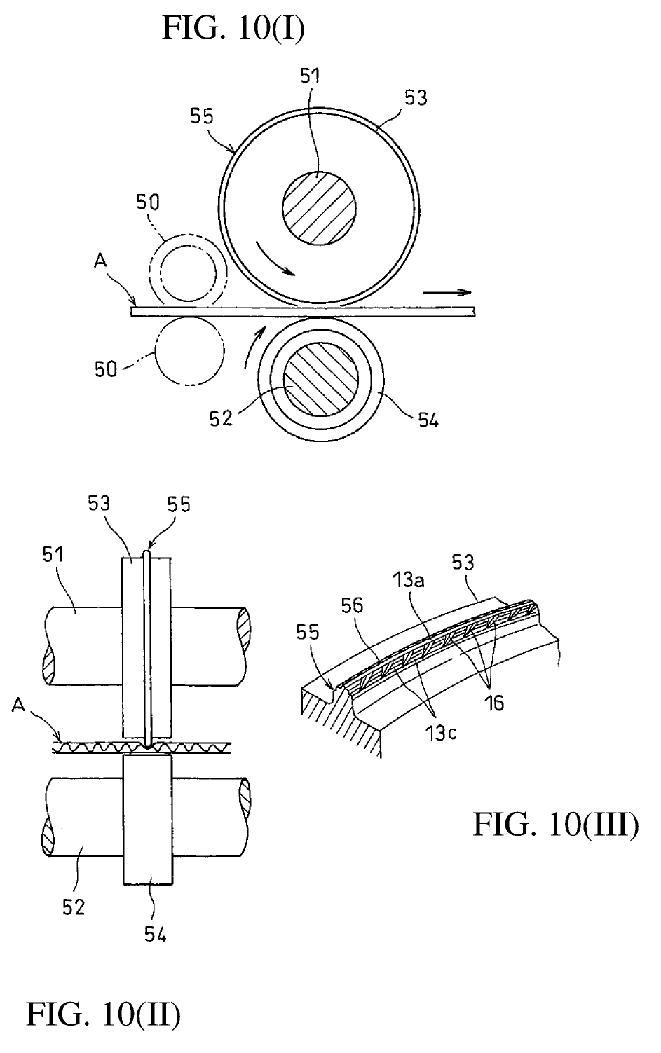

FIGS. 10(I) to 10(II) show another crease-forming device. This device includes an upper and lower pair of feed rollers 50 for feeding a corrugated cardboard sheet A in the direction of the arrow in FIG. 10(I), and an upper and lower pair of rotary shafts 51 and 52 provided downstream of the feed rollers 50 and configured to be rotated in opposite directions to each other. A crease-forming roll 53 as a pressed crease-forming member is mounted on the upper rotary shaft 51, while a support roll 54 as a support member having a smooth surface with no protrusions and recesses is mounted on the lower rotary shaft 52.

The crease-forming roll 53 has, on its outer periphery, an annular crease-forming rib 55 having, at the outer periphery thereof, a crease-forming portion 56 having an arc-shaped cross-section. The crease-forming portion 56 includes a center rib 13a, discontinuous rib portions 13c, grooves 15, and cross grooves 16 which are, if flattened, exactly identical in shape, structure and arrangement to their counterparts shown in FIGS. 3 to 5. Their details are however not shown in FIG. 9(II).

As the crease-forming portion 56, a crease-forming portion similar to the one shown in any of FIGS. 7, 8 and 11 may be used.

With this crease-forming device, when the corrugated cardboard sheet A is fed into between the crease-forming roll 53 and the support roll 54 by the pair of feed rollers 50 with the rolls 53 and 54 rotating in the directions shown by the arrows in FIG. 10(I), the crease-forming portion 56 on the outer periphery of the annular crease-forming rib 55 of the crease-forming roll 53 presses one side of the corrugated cardboard sheet A, thereby forming a crease L, similar to the crease L shown in FIGS. 3 to 5. Thus, the corrugated cardboard sheet A can be bent along the crease L with high accuracy.

When the corrugated cardboard sheet A is bent by 180 degrees along the crease L, the corrugated cardboard sheet A tends to bulge at its portions along both sides of the crease L. Since such bulges could make it difficult to accurately bend the corrugated cardboard sheet A, members may be provided in proximity to the respective sides of the pressed crease-forming member for pressing and crushing the portions of the corrugated cardboard sheet A along both sides of the crease L, thereby preventing the formation of bulges.

In the embodiments, creases are formed in corrugated cardboard sheets A, but the creasing devices of the present invention may be used to form creases not only in corrugated cardboard sheets A but in non-corrugated cardboard.

### DESCRIPTION OF THE NUMERALS

A. Corrugated cardboard sheet
1. Support plate
2, 32. Template
3. Board
10, 40. Pressed crease-forming member
11, 41. Strip-shaped member
12, 42, 56. Crease-forming portion
13. Rib
13a. Center rib
13b. Ribs
13c. Discontinuous rib portion
14. Top
15. Groove
15a. Groove bottom
15b. Discontinuous groove portion
16. Cross groove
30. Anvil roll
31. Die roll
33. Arc-shaped board
53. Crease-forming roll
54. Support roll
55. Crease-forming rib

1. A pressed crease-forming member comprising a strip-shaped member made from metal and having a wall thickness of 7.0 mm or less, the strip-shaped member including a crease-forming portion at one end of the strip-shaped member, the crease-forming portion being capable of forming a crease in a sheet along which the sheet can be bent, by pressing the crease-forming portion into the sheet,
wherein:
the crease-forming portion has a surface on which are formed three or a larger-than-three odd number of ribs extending in a longitudinal direction of the crease-forming portion and having narrow widths which are substantially equal to each other, the ribs comprising a center rib located at a widthwise center of the crease-forming portion, and the remaining ribs, each half of the remaining ribs being arranged on each side of the center rib;
the ribs have tops, of which at least the top of the center rib is chamfered, each of the ribs is formed into a protruding shape by two side surfaces extending toward the top, grooves are formed between the adjacent ribs, the side surfaces of the respective ribs extend from the respective tops of the ribs and are connected to opposed pairs of side surfaces of the grooves, whereby each of the grooves is formed into a recessed shape by the side surfaces of the groove;
the tops of the ribs are arranged such that with the crease-forming portion facing downward, the top of the center rib is located at a lowest level of all the tops of the ribs, the tops of the odd number of ribs are formed, as a whole, into a convex shape, and recesses in the form of the grooves and protrusions in the form of the ribs other than the center rib are continuously formed on both sides of a protrusion in the form of the center rib; and
a plurality of cross grooves are formed on each of two sides of the center rib so as to extend in directions in which the respective cross grooves cross the center rib, so as to be spaced apart from each other in a longitudinal direction of the crease-forming portion, and so as to separate at least one of the ribs on said each of the two sides of the center rib into discontinuous rib portions.

2. The pressed crease-forming member of claim 1, wherein a protruding amount of the top of the center rib is larger than protruding amounts of the tops of the ribs other than the center rib.

3. The pressed crease-forming member of claim 1, wherein the two side surfaces of at least the center rib are smooth inclined surfaces inclined in opposite directions to each other and having no corners such that at least the center rib is tapered.

4. (canceled)

5. (canceled)

6. (canceled)

7. (canceled)

8. A pressed crease-forming member for use as a crease-forming roll of a creasing device comprising a support roll and the crease-forming roll which are configured to be rotated in opposite directions to each other, the crease-forming member including a crease-forming portion including, on an outer periphery of the crease-forming portion, an annular crease-forming ring, the creasing device being configured such that the crease-forming ring forms a groove-shaped crease in a sheet along which the sheet can be bent, when the sheet is fed into between the support roll and the crease-forming roll,
wherein:
the crease-forming ring has an outer peripheral surface on which are formed three or a larger-than-three odd number of annular ribs extending in a circumferential direction of the crease-forming portion having narrow widths which are substantially equal to each other, the annular ribs comprising an annular center rib located at a widthwise center of the crease-forming portion, and the remaining annular ribs, each half of the remaining annular ribs being arranged on each side of the annular center rib;
the annular ribs have tops, of which at least the top of the annular center rib is chamfered, each of the annular ribs is formed into a protruding shape by two side surfaces extending toward the top, recessed grooves are formed between the adjacent annular ribs, the side surfaces of the respective annular ribs extend from the respective tops of the annular ribs and are connected to opposed pairs of side surfaces of the recessed grooves, each of the recessed grooves is formed into a recessed shape by each pair of the side surfaces of the recessed grooves;
the tops of the annular ribs are arranged such that the top of the annular center rib is largest in outer diameter of all the tops of the annular ribs, the tops of the odd number of ribs are formed, as a whole, into a convex shape, recesses in the form of the recessed grooves and protrusions in the form of the annular ribs other than the annular center rib are continuously formed on both sides of a protrusion in the form of the annular center rib; and
a plurality of cross grooves are formed on each of two sides of the center rib so as to extend in directions in which the respective cross grooves cross the center rib, so as to be spaced apart from each other in a longitudinal direction of the crease-forming portion, and so as to separate at least one of the ribs on said each of the two sides of the center rib into discontinuous rib portions.

9. The pressed crease-forming member of claim 2, wherein the two side surfaces of at least the center rib are smooth inclined surfaces inclined in opposite directions to each other and having no corners such that at least the center rib is tapered.
